(19) United States
(12) Patent Application Publication
(10) Pub. No.: US 2021/0191991 A1
(43) Pub. Date: Jun. 24, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kuniko OISHI, Kanagawa (JP)

(73) Assignee: FUJI XEROX CO., LTD., Tokyo (JP)

(21) Appl. No.: 16/864,548

(22) Filed: May 1, 2020

(30) Foreign Application Priority Data
Dec. 20, 2019 (JP) 2019-230673

(51) Int. Cl. G06F 16/93; G06K 9/00; G06F 16/16

(52) U.S. Cl. CPC G06F 16/93; G06K 9/00463; G06K 2209/01; G06F 16/16; G06K 9/00469

(57) ABSTRACT

An information processing apparatus includes a memory having stored a folder that is set to perform an operation related to a document if the document is registered in the folder and a log of documents registered in the folder, and one or more processors configured to, if the document is selected, perform control to display the log.

### Cross-Reference to Related Applications

This application is based on and claims priority under 35 USC 119 from Japanese Patent Application No. 2019-230673 filed Dec. 20, 2019.

### BACKGROUND

### (i) Technical Field

The present disclosure relates to an information processing apparatus and a non-transitory computer readable medium.

### (ii) Related Art

Japanese Unexamined Patent Application Publication No. 2006-229305 discloses a network document management system. The network document management system includes a digital multi-function apparatus, a document management server, and a client, interconnected to each other. The digital multi-function apparatus reduces time for sorting by recognizing a form of scan image data and automatically switching storage destinations and transmits the scan image data. The document management server stores and manages received image data by associating the received image data with user information. The client views a document stored on the document management server. The client has a unit that creates form information and transmits the form information to the document management server. The document management server includes a unit that authenticates a user, a unit that stores format information received from the client in association with a folder, and a unit that searches for the format information received from the client, newly creates a folder if the format information is unstored, and stores the folder as corresponding information. The multi-function apparatus includes a unit that transmits folder information and format information to the document management server and a unit that determines a storage destination of document data in accordance with search results received from the document management server.

When a user stores a scanned document on a document management server, the user selects a storage destination folder in front of a multi-function apparatus and selects a storage destination folder on a client personal computer (PC) in advance. Japanese Unexamined Patent Application Publication No. 2010-251973 discloses a technique of determining, if the user causes the multi-function apparatus to scan a document, a specific folder in accordance with a storage log of documents scanned in the past by the user and produces in the specific folder a shortcut key to the currently scanned document.

A folder may be set to perform an operation on a document in response to the registration of the document in the folder. If the contents of the operation are indicated only by the name of the document, the user may erroneously select a folder in which the document is to be registered.

### SUMMARY

Aspects of non-limiting embodiments of the present disclosure relate to providing an information processing apparatus that, when a document is registered in a folder that is set such that an operation related to the document is performed in response to the registration of the document, controls more an erroneous selection of folders than when the contents of the operation are indicated only by the folder name of the folder.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a memory having stored a folder that is set to perform an operation related to a document if the document is registered in the folder and a log of documents registered in the folder, and one or more processors configured to, if the document is selected, perform control to display the log.

### BRIEF DESCRIPTION OF THE DRAWINGS

Exemplary embodiment of the present disclosure will be described in detail based on the following figures, wherein:

FIG. 1 illustrates a modular configuration of an exemplary embodiment;

FIG. 2 illustrates an example of a system configuration of the exemplary embodiment;

FIG. 3 illustrates a process example of the exemplary embodiment;

FIG. 4 is a flowchart illustrating a process example of the exemplary embodiment;

FIG. 5 is a flowchart illustrating a process example of the exemplary embodiment;

FIG. 6 illustrates an example of a target document of the exemplary embodiment;

FIG. 7 illustrates an example of a data structure of a document attribute information table;

FIG. 8 is a flowchart illustrating a process example of the exemplary embodiment;

FIG. 9 illustrates an example of a data structure of a folder information table;

FIG. 10 illustrates an example of a data structure of a folder log information table;

FIG. 11 illustrates a process example of the exemplary embodiment;

FIG. 12 illustrates a process example of the exemplary embodiment; and

FIG. 13 illustrates a display example of a screen in accordance with the exemplary embodiment.

### DETAILED DESCRIPTION

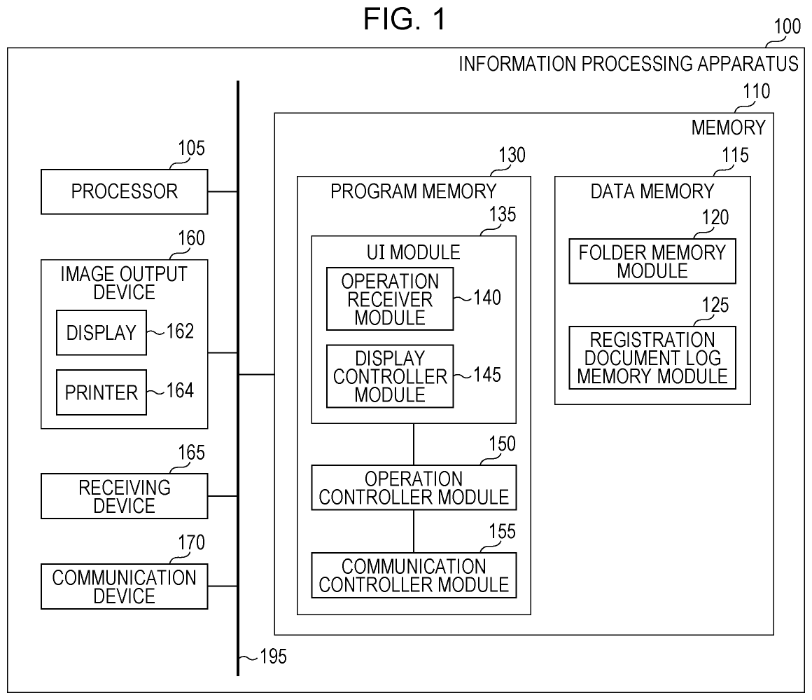

Exemplary embodiment of the disclosure is described below with reference to the drawings. FIG. 1 illustrates a modular configuration of the exemplary embodiment. The term “module” refers to a software component (including a computer program) that is logically separable, or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information”. The modules may correspond to the functions in a one-to-one correspondence. In software implementation, one module may be configured of one program or multiple modules may be configured of one program. One module may be configured of multiple programs. Multiple modules may be executed by a single computer. A single module may be executed by multiple computers in a distributed environment or a parallel environment. One module may include another module.

In the discussion that follows, the term “connection” refers to not only a physical connection but also a logic connection (such as an exchange of data, instructions, data reference relationship, or login).

The term “predetermined” means that something is decided in advance of a process of interest. The term predetermined is thus intended to refer to something that is decided in advance of a process of interest in the exemplary embodiment. Even after a process in the exemplary embodiment has started, the term predetermined refers to something that is decided in advance of a process of interest depending on a condition or a status of the exemplary embodiment at the present point of time or depending on a condition or status of the exemplary embodiment heretofore continuing down to the present point of time. If plural predetermined values are used, the predetermined values may be different from each other, or two or more of the predetermined values (including all the values) may be equal to each other.

A statement that “if A, B is to be performed” is intended to mean that it is determined whether something is A, and that if something is determined as A, an action B is to be taken. The statement becomes meaningless if the determination as to whether something is A is not performed. If a discussion is made of events “A, B, and C”, the discussion is applicable to at least one of the events “A, B, and C” unless otherwise noted. For example, the discussion is applicable to the case in which only the event A is selected.

The term “system” and the term “apparatus” refer to an arrangement where multiple computers, a hardware configuration, and an apparatus are interconnected via a communication network (including a one-to-one communication connection). The term system and the term apparatus also refer to an arrangement that includes a single computer, a hardware configuration, and an apparatus. The term system and the term apparatus have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate.

An information processing apparatus 100 of the exemplary embodiment has a control function to perform an operation set in a folder on a document if the document is registered in the folder. Referring to FIG. 1, the information processing apparatus 100 includes a processor 105, memory 110, image output device 160, receiving device 165, and communication device 170.

FIG. 1 is a block diagram and illustrates a hardware configuration of a computer that implements the exemplary embodiment. The hardware configuration of the computer on which a program as the exemplary embodiment runs is the computer in FIG. 1. Specifically, the computer is a personal computer or a server. More specifically, the computer includes the processor 105 and the memory 110 as a storage device.

The information processing apparatus 100 may include one or more processors 105. The processor 105 may include a central processing unit (CPU) or a microprocessor. If multiple processors 105 are employed, they may be tightly-coupled multiprocessors or loosely-coupled multiprocessors. For example, multiple processor cores may be mounted in a single processor 105. Multiple processors may be connected via a communication network to work as a virtual single computer in a system. Specifically, loosely-coupled multiprocessors may be configured as a cluster system or a computer cluster. The processor 105 executes a program on a program memory 130.

The memory 110 may be a semiconductor memory, such as a register or a cache memory, in the processor 105 or a storage device, such as a random-access memory (RAM) and a read-only memory (ROM). The memory 110 may be a long-life internal memory device, such as a hard disk drive (HDD) or a solid-state drive (SSD), or an external storage device or an auxiliary storage device, such as a compact disk (CD), digital versatile disk (DVD), Blu-ray (registered trademark) disc, universal serial bus (USB) memory, or memory card. The memory 110 may also be a storage device in a server connected via a communication network.

The memory 110 includes the program memory 130 that stores programs and data memory 115 that stores data. The program memory 130 and the data memory 115 may store not only programs of illustrated modules but also a program, such as an operating system (OS) used to start up the computer.

The information processing apparatus 100 may include, in addition to the processor 105 and memory 110, the image output device 160, receiving device 165, and communication device 170. They are interconnected to each other by a bus 195.

The image output device 160 includes a display 162 and printer 164. The display 162, such as a liquid-crystal display, organic electroluminescent (EL) display, or speaker, outputs operation results from the processor 105 and data from the data memory 115. The printer 164, such as a printer and a copying machine, prints the operation results of the processor 105 and the data on the data memory 115.

The receiving device 165 receives data responsive to user operations (including action, voice, and eye gaze) on a keyboard, mouse, touch screen, microphone, or camera (including an eye-gaze detection camera) or image data resulting from the scanning operation of a scanner.

The communication device 170 is a communication network interface, such as a network card, and is used to connect to other apparatuses via the communication network.

The computer program of the exemplary embodiment is installed on the hardware configuration. The exemplary embodiment is thus implemented by causing software and hardware to work in cooperation.

The hardware configuration in FIG. 1 is illustrated for exemplary purposes only. The exemplary embodiment is not limited to the hardware configuration in FIG. 1. The exemplary embodiment may be any configuration as long as the configuration implements the modules of the exemplary embodiment. For example, the processor 105 may include a graphics processing unit (GPU) (including general-purpose computing on graphics processing units (GPGPU)). Part of the modules may be implemented using dedicated hardware (such as application specific integrated circuit (ASIC)) or a reconfigurable integrated circuit (such as field-programmable gate array (FPGA)). In another example, some modules may be in an external system and connected to the system of FIG. 1 via a communication network. In yet another example, a multiple number of the system in FIG. 1 may be interconnected to each other via a communication line such that the systems operate in concert with each other. One of the modules may be incorporated not only in a personal computer, but also in a mobile information and communication device (such as a mobile phone, smart phone, mobile device, or wearable computer), information appliance, robot, copying machine, fax, scanner, printer, multi-function device (an image processing apparatus having at least two of the functions of the scanner, printer, copying machine, and fax).

The processor 105 is connected via the bus 195 to the memory 110, image output device 160, receiving device 165, and communication device 170. The processor 105 performs an operation in accordance with a computer program that describes an execution sequence of each module serving as the program on the program memory 130. When the receiving device 165 receives a user operation, the processor 105 performs the operation of the module corresponding to the user operation. The processor 105 stores the operation results on the data memory 115 and outputs the operation results to the image output device 160, and communicates with another apparatus via the communication device 170.

The memory 110 includes the data memory 115 and program memory 130 and is connected via the bus 195 to the processor 105, image output device 160, receiving device 165, and communication device 170.

The data memory 115 stores a folder memory module 120 and registration document log memory module 125.

The folder memory module 120 stores a folder that is set to perform an operation on a document if the document is registered in the folder.

The word “folder” is set to perform the operation on the document if the document is registered in the folder.

When the document is selected, control may be performed to display the log of the folder on a display if the relationship between the folder and the document is established as described below.

A folder that is set to perform an operation related to a document if the document is registered in the folder is designated as a first folder. Specifically, the first folder may serve a storage destination of the document. The first folder stores the document in association with the log of the document registered in the first folder. A folder that stores the first folder is designated as a second folder. In other words, the second folder serves as a parent in the tree structure of the first folder. Similarly, the first folder serves as a child in the tree structure of the second folder. The second folder may include multiple first folders. If a document in the second folder is selected, control may be performed such that a log in the first folder under the second folder is displayed on the display. In such a case, the second folder includes the selected document and the first folder and the relationship between the document and the first folder is a sibling relationship in the tree structure.

An “operation related to the document” means any operation that is performed on the document when the document is registered in the folder. Such operations may include modifying the document itself and setting a registration destination without modifying the document. The operations further include an operation of adding text to the document by character-recognizing an image in the document, an operation of modifying the name of the document using contents of the document, and an operation of setting the registration destination of the document in response to the contents of the document and registering the document at the registration destination.

The setting to perform the operation related to the document in response to the registration of the document may be performed if an operation corresponding to each folder is set. For example, the operation may be performed on the information processing apparatus 100 by causing the folder to correspond to the operation or the operation may be performed on a cloud system by causing the second folder to correspond to the cloud system and by causing the first folder to correspond to a service provided by the cloud system.

The folder memory module 120 stores a folder information table 900 in FIG. 9. FIG. 9 illustrates an example of the data structure of the folder information table 900. The folder information table 900 includes a folder identification (ID) column 905, folder name column 910, and registration destination column 915. The folder ID column 905 stores information uniquely identifying each folder (specifically, a folder identification (ID)). The folder name column 910 stores the folder name of each folder. The registration destination column 915 stores the registration destination.

In the first row of the folder information table 900, the folder ID F0001 indicates “contract attribute addition A” as a folder name and “service A module 212A of processing apparatus 210” as a registration destination. In the second row of the folder information table 900, the folder ID F0002 indicates “quotation attribute addition A” as a folder name and “service B module 212B of the processing apparatus 210” as a registration destination. The first row of the folder information table 900 indicates that if a document is registered in the contract attribute addition A folder, the service A module 212A of the processing apparatus 210 performs the operation on the document.

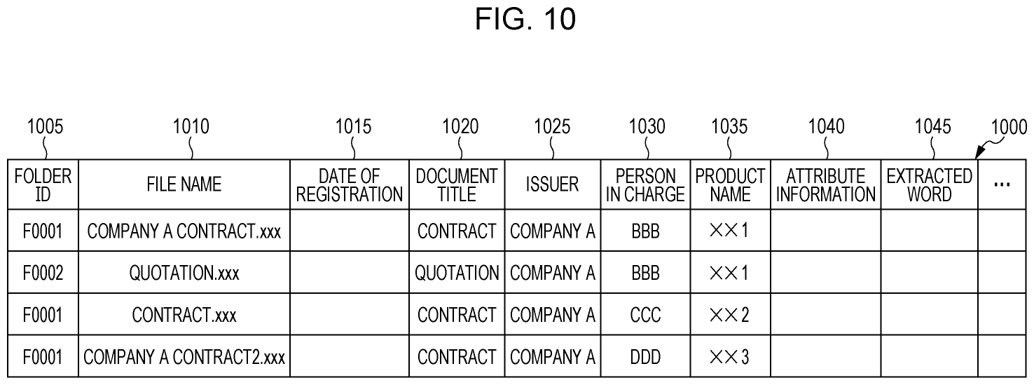

The registration document log memory module 125 stores the log of the document registered in the folder. The log includes a folder, a document registered in the folder, attribute of the document (including the type of the document), and date of registration. The log may further include a word extracted from the document registered in the folder. Specifically, the registration document log memory module 125 stores a folder log information table 1000 in FIG. 10. FIG. 10 illustrates an example of the data structure of the folder log information table 1000. The folder log information table 1000 includes a folder ID column 1005, file name column 1010, data-of-registration column 1015, document title column 1020, issuer column 1025, person-in-charge column 1030, product name column 1035, attribute information column 1040, and extracted word column 1045. The folder ID column 1005 stores the folder ID of each folder. The file name column 1010 stores the file name of each file. The data-of-registration column 1015 stores the date of registration. The document title column 1020 stores the title of each document. The issuer column 1025 stores the name of an issuer. The person-in-charge column 1030 stores the name of the person in charge. The product name column 1035 stores the name of a product. The attribute information column 1040 stores attribute information. The extracted word column 1045 stores an extracted word.

The program memory 130 stores a user interface (UI) module 135, operation controller module 150, and communication controller module 155. Each module in the program memory 130 is executed by the processor 105. In the following discussion of each module, contents of the operations performed by the processor 105 are described.

The UI module 135 includes an operation receiver module 140 and display controller module 145 and is connected to the operation controller module 150.

The operation receiver module 140 detects a user operation received by the receiving device 165. The user operations include selecting a document, moving a document onto a folder, and registering a document in the folder.

The display controller module 145 performs control to display the log on the display 162 in response to the selection of the document.

The selection of the document refers the state in which the document has been selected as a registration target in response to the user action before the target document is registered. For example, the selection of the document refers to (1) moving a cursor onto the document, (2) clicking the right button of a mouse after moving the cursor on the document, or (3) operating a hot key after moving the cursor on the document. Such an action, if detected, is determined to indicate the selection of the document.

The log to be displayed may include information related to the folder in which the document is registered. The information related to the folder may be information indicating the folder and, for example, may be the identifier of the folder, the name of the folder, and/or a uniform resource locator (URL) where the folder is located.

When the selected document has been moved in the document, the display controller module 145 may perform control to display the log of the folder on the display 162.

The phrase “when the document has been moved in the folder” refers to the state in which the document is superimposed on at least part of the folder. Specifically, the icon of the document may be fully or partially superimposed on the icon of the folder in response to user operation.

The phrase “when the document has been moved in the folder” also refers to the state in which the document is shifted on the folder in response to the user operation before the target document is registered. This state typically refers to a state immediately prior to the dropping of a drag and drop operation. By displaying the log of the folder in this state, the user may determine whether to perform the drop action. Specifically, the user refers to the log and performs the drop action if the user determines that the folder is where the document is to be registered. If the user determines that the folder is not where the document is registered, the user may perform a drag operation to another folder instead of performing the drop operation.

The operation controller module 150 is connected to the UI module 135 and communication controller module 155. If a movement and registration operation to move and register a selected document in a folder in the log displayed on the display 162 is performed, the operation controller module 150 registers the document in the folder.

The movement and registration operation to move and register a selected document in a folder in the log displayed on the display 162 refers to a drag operation to drag the document onto the displayed log followed by a drop operation. The movement and registration operations do not simply refer to a drag and drop operation of the document on the icon of the folder displayed on the display 162 but dragging and then dropping the document on the folder (typically the folder name) in the displayed log.

A movement operation may be performed to move a selected document. If a word extracted from the selected document matches a word in the log stored on the registration document log memory module 125, the operation controller module 150 may register that document in the folder as a destination.

The word may be extracted from a text if the document includes the text. If the document is an image, character recognition may be performed on the image and a word may be extracted from a text as a result of the character recognition.

The word in the log stored on the memory is the word in the log in the folder serving as a destination.

If a movement operation is performed on a selected document and the type of the selected document is similar to the type of a document registered in the folder serving as a destination, the operation controller module 150 may register the document in that folder.

The “type” refers to the location of an element forming the document. The type is a concept including a form, a format, and a template. The elements may include entry columns and tables, listing a title, issuer, name of a person in charge. Depending on the type, the locations are fixed. For example, the type of the document may be a location of a table included in the document. The types of the documents are similar if each of the difference between the locations of the top right corners of two documents and the difference between the locations of the top left corners of two documents falls within a predetermined range. A slight error may be permitted. The permissible error is a predetermined threshold value. If the two values fully agree with each other, they are also determined to be similar.

If the movement operation is performed on the selected document and the type of the selected document is not similar to the document registered in the folder serving as the destination, the operation controller module 150 may perform control to display a warning against registering the document in the folder on the display 162.

The communication controller module 155 is connected to the operation controller module 150. The communication controller module 155 starts to communicate with the processing apparatus 210 in response to the registration of the document. For example, the communication controller module 155 makes communications to request the processing apparatus 210 to perform an operation, transmits the document to the processing apparatus 210, or receives operation results from the processing apparatus 210.

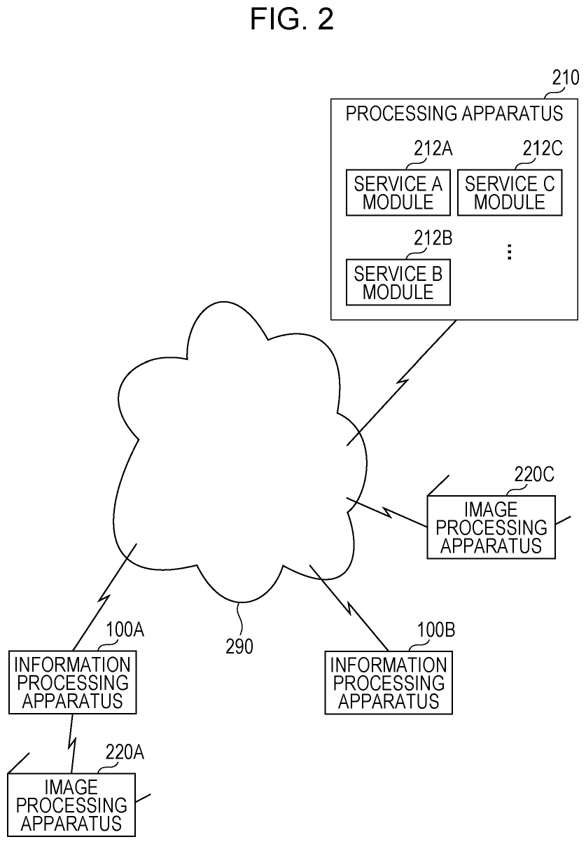

FIG. 2 illustrates a system configuration of the exemplary embodiment. Information processing apparatuses 100A and 100B, processing apparatus 210, and image processing apparatus 220C are interconnected to each other via a communication network 290. The communication network 290 may be a wired network, wireless network, or a combination thereof. For example, the communication network 290 may be the Internet and/or intranet service as a communication infrastructure.

The processing apparatus 210 has functions provided by the service A module 212A, service B module 212B, and service C module 212C. The functions of the processing apparatus 210 may be implemented as a cloud service.

The information processing apparatus 100A is connected to the image processing apparatus 220A via a communication network. The information processing apparatus 100A may use the image processing apparatus 220A. The information processing apparatus 100B may use the image processing apparatus 220C via the communication network 290.

The user of the information processing apparatus 100 causes the image processing apparatus 220 to read a paper document and registers on the information processing apparatus 100 a digital document of the paper document in the folder corresponding to the service A module 212 in the processing apparatus 210. The digital document is thus transmitted to the service A module 212 of the processing apparatus 210 corresponding to the folder. The service A module 212 performs an operation on the digital document and transmits the results of the operation to the information processing apparatus 100.

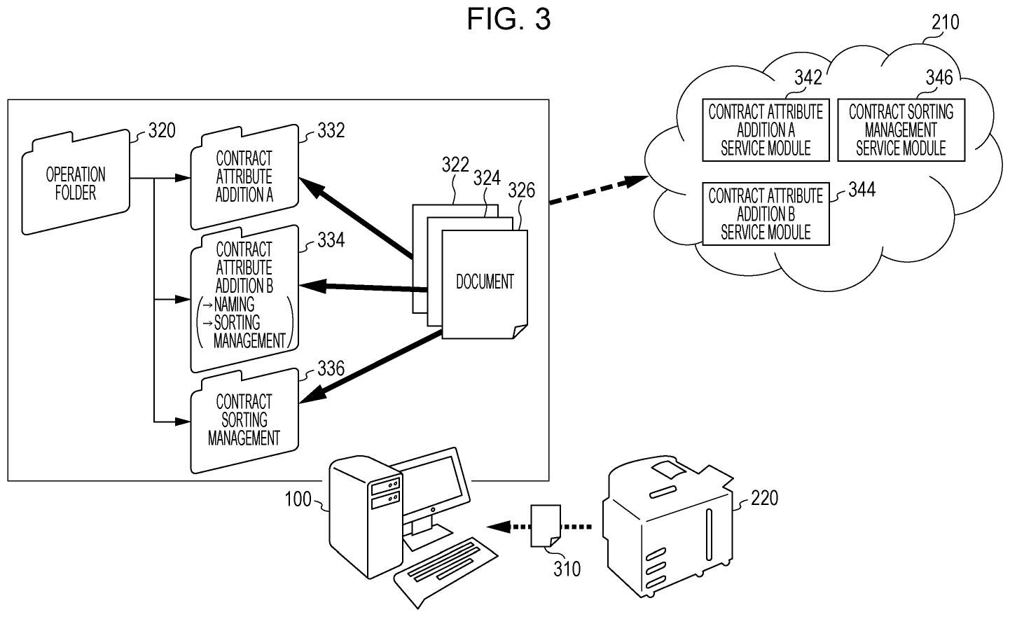

FIG. 3 illustrates a process example of the exemplary embodiment. The processing apparatus 210 includes a contract attribute addition A service module 342, contract attribute addition B service module 344, and contract sorting management service module 346. The contract attribute addition A service module 342 and other modules are an example of the service module 212 in FIG. 2.

An image processing apparatus 220 reads a paper document to create a document 310. The image processing apparatus 220 then transmits the document 310 to the information processing apparatus 100. Referring to FIG. 2, like the image processing apparatus 220A, the image processing apparatus 220 is connected to the information processing apparatus 100. The image processing apparatus 220 may not only store directly the document 310 onto the information processing apparatus 100 but may also store the document 310 onto the information processing apparatus 100 via the communication network 290 through a network scan function in the same way as in the image processing apparatus 220C connected to the communication network 290.

The information processing apparatus 100 stores under an operation folder 320 a contract attribute addition A folder 332, contract attribute addition B folder 334 and contract sorting management folder 336. The operation folder 320 is typically displayed on a desk top. When the operation folder 320 is opened, the contract attribute addition A folder 332, contract attribute addition B folder 334 and contract sorting management folder 336 are displayed. For example, a document 322 is stored in the contract attribute addition A folder 332, a document 324 is stored in the contract attribute addition B folder 334, and a document 326 is stored in the contract sorting management folder 336. b

The document 322 is transferred to the contract attribute addition A service module 342 of the processing apparatus 210 assigned to the contract attribute addition A folder 332. The contract attribute addition A service module 342 then performs an operation for attribute addition A on the document 322. The file name of the document 322 read by the image processing apparatus 220 may be date. The contract attribute addition A service module 342 performs character recognition on a title region of the document 322 and performs an operation to set the character recognition results to be a file name.

The document 324 is transferred to the contract attribute addition B service module 344 of the processing apparatus 210 assigned to the contract attribute addition B folder 334. The contract attribute addition B service module 344 performs an operation for attribute addition B on the document 324. The file name of the document 324 read by the image processing apparatus 220 may be date. The contract attribute addition B service module 344 performs character recognition on a title region of the document 324 and sets the character recognition results to be the file name of the document 324. In response to the character recognition results, the contract attribute addition B service module 344 performs an operation of sorting the document 324 into storage locations.

The document 326 is transferred to the contract sorting management service module 346 of the processing apparatus 210 assigned to the contract sorting management folder 336. The contract sorting management service module 346 performs an operation for sorting management on the document 326. For example, the contract sorting management service module 346 performs character recognition on a text region of the document 326 and performs an operation to sort the document 326 into storage locations in accordance with the character recognition results.

The operation folder 320 may be assigned to the processing apparatus 210. If multiple processing apparatuses 210 are used, multiple operation folders 320 are also used.

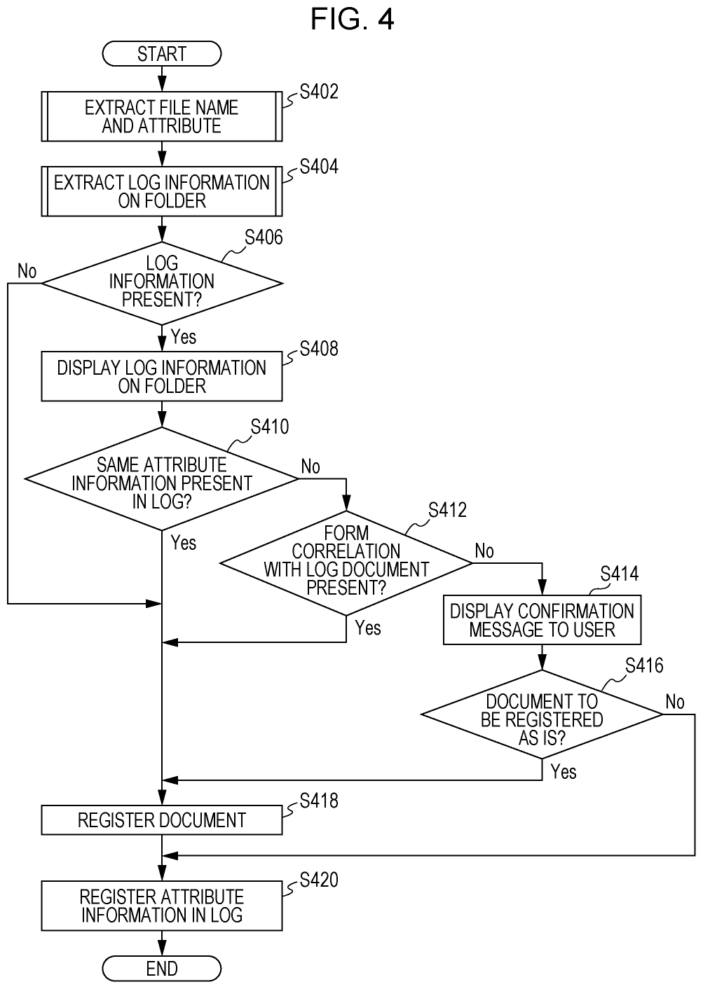

FIG. 4 is a flowchart illustrating a process example of the exemplary embodiment.

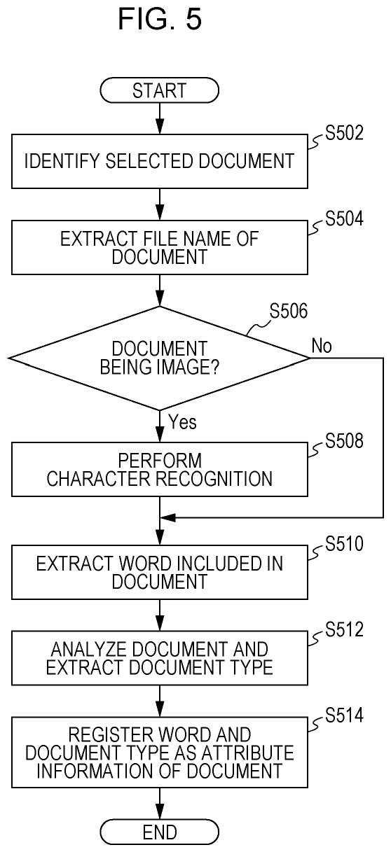

In step S402, the information processing apparatus 100 extracts the file name and attribute of a target document. The target document is a document that is selected by the user to register in the folder. The details of step S402 are described with reference to a flowchart in FIG. 5.

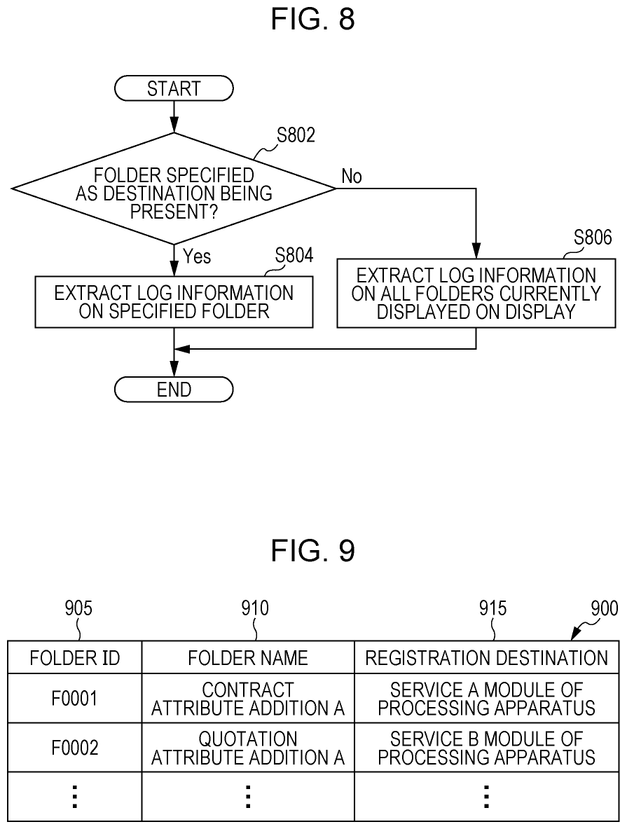

In step S404, the information processing apparatus 100 extracts log information on a target folder. The target folder is where the target document is to be registered. The details of step S404 are described with reference to a flowchart in FIG. 8.

In step S406, the information processing apparatus 100 determines whether the log information is included in the target folder. If the log information is included in the target folder, processing proceeds to step S408; otherwise, processing proceeds to step S418.

In step S408, the information processing apparatus 100 performs control to display the log information on the folder on the display 162.

In step S410, the information processing apparatus 100 determines whether the target document has the same attribute information as the attribute information in the log. If the target document has the same attribute information, processing proceeds to step S418; otherwise, processing proceeds to step S412.

In step S412, the information processing apparatus 100 determines whether the target document has a correlation in form to a log document. If the target document has a form correlation to the log document, processing proceeds to step S418; otherwise, processing proceeds to step S414. If the target document has a form correlation, the type of the target document is similar to the type of the document registered in the folder.

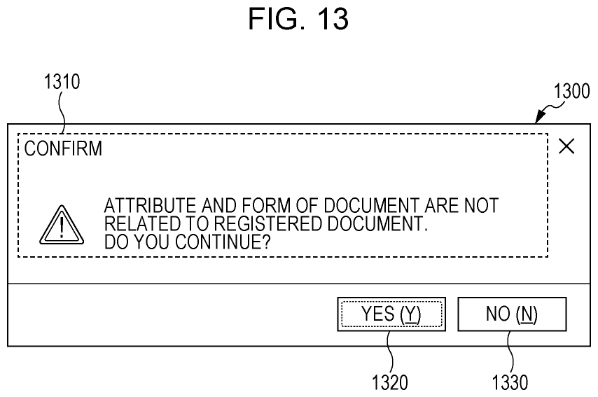

In step S414, the information processing apparatus 100 displays a confirmation message to the user. The confirmation message is described below with reference to FIG. 13.

In step S416, the information processing apparatus 100 determines whether the target document is to be registered as is. If the target document is to be registered as is, processing proceeds to step S418; otherwise, processing proceeds to step S420.

In step S418, the information processing apparatus 100 registers the target document in the target folder.

In step S420, the information processing apparatus 100 registers the attribute information in the log. Specifically, the information processing apparatus 100 registers information related to the registered document in the folder log information table 1000.

FIG. 5 is a flowchart illustrating a process example of the exemplary embodiment.

In step S502, the information processing apparatus 100 identifies the selected document.

In step S504, the information processing apparatus 100 extracts the file name of the document.

In step S506, the information processing apparatus 100 determines whether the document is an image. If the document is an image, processing proceeds to step S508; otherwise, processing proceeds to step S510. In step S508, the information processing apparatus 100 performs character recognition.

In step S510, the information processing apparatus 100 extracts a word included in the document. The word included in the document corresponds to character recognition results in step S508 if the document is an image. If the document includes text produced by a document producing program, the word included in the document corresponds to the text portion of the document. The word may be extracted using language processing through morphological analysis. Also, a phrase may be extracted using term frequency and inverted document frequency (TF-IDF).

In step S512, the information processing apparatus 100 analyzes the document and extracts the type of the document. The type of the document may be a location of a table included in the document.

In step S514, the information processing apparatus 100 registers the results in steps 5510 and 5512 as the attribute information on the document.

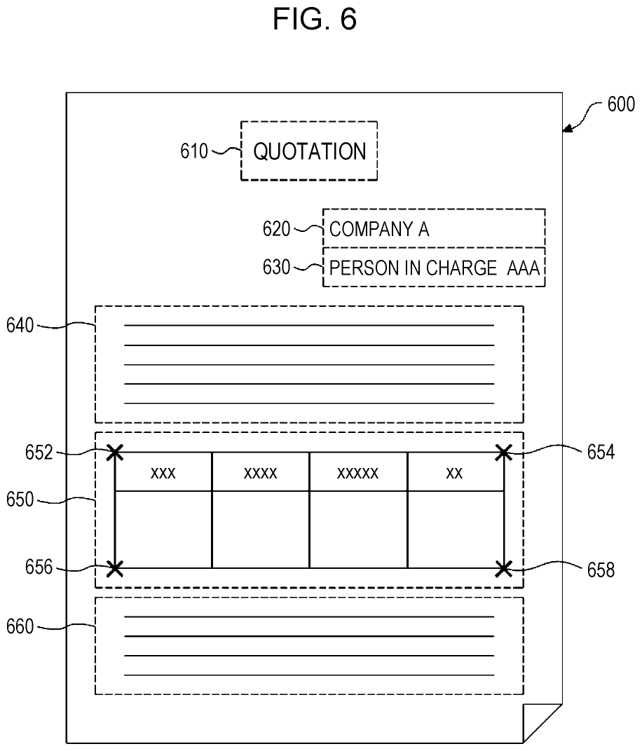

FIG. 6 illustrates an example of a document 600 serving as a target of the exemplary embodiment. The document 600 includes a document title region 610, issuer region 620, person-in-charge region 630, text region 640, table region 650, and text region 660.

In step S510, a target region from which to detect the word may be the whole document 600, a predetermined region, such as the document title region 610, the issuer region 620 or the person-in-charge region 630 in the document 600, or a predetermined region having the number of characters equal to or above a predetermined value, such as the text region 640 or the text region 660 in the document 600.

The number of rows forming a table, the number of columns, or a word written in each cell may be extracted from the table region 650.

Information on the type of the document 600 corresponds to the location of each of the document title region 610, issuer region 620, person-in-charge region 630, and table region 650. A table is located in the table region 650. The location of the table may be a table top left corner position 652, table top right corner position 654, table bottom left corner position 656, and table bottom right corner position 658. The location of the table may be the table top left corner position 652 and the table top right corner position 654. The table bottom left corner position 656 and the table bottom right corner position 658 may be different depending on the number of rows in the table. The locations of the table top left corner position 652 and the table top right corner position 654 may be typically similar as long as the documents are of the same type.

A document attribute information table 700 is created using the attribute of the document 600 in FIG. 6 and the extracted word.

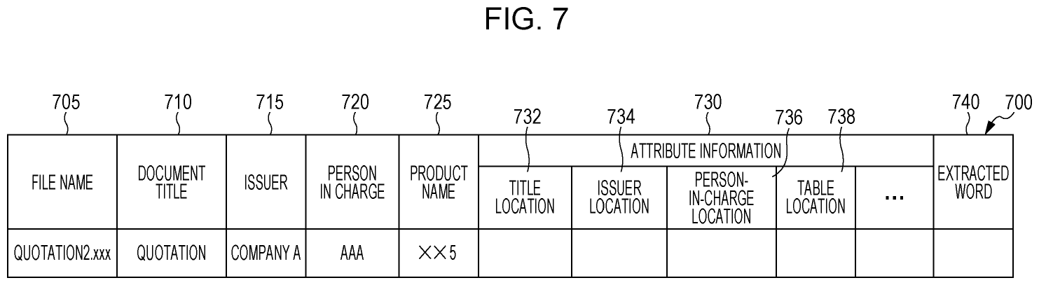

FIG. 7 illustrates an example of the data structure of the document attribute information table 700. The document attribute information table 700 includes a file name column 705, document title column 710, issuer column 715, person-in-charge column 720, product name column 725, attribute information column 730, and extracted word column 740. The attribute information column 730 includes a title location sub-column 732, issuer location sub-column 734, person-in-charge sub-column 736, and table location sub-column 738. The file name column 705 stores the file name of each document. The document title column 710 stores the title written in the document. The issuer column 715 stores the issuer written in the document. The person-in-charge column 720 stores the name of a person in charge. The product name column 725 stores the product name written in the document. The attribute information column 730 stores attribute information. The title location sub-column 732 stores the location where the title is written. The issuer location sub-column 734 stores the location where the issuer is written. The person-in-charge sub-column 736 stores the location where the name of the person in charge is written. The display location sub-column 738 stores the location where the table is written. The extracted word column 740 stores an extracted word.

FIG. 8 is a flowchart illustrating a process example of the exemplary embodiment. In step S802, the information processing apparatus 100 determines whether a folder specified to be a destination is present. If a folder specified to be a destination is present, processing proceeds to step S804; otherwise, processing proceeds to step S806. The presence of the folder specified to be a destination corresponds to the user operation to move the selected document to the folder or the user operation to register the selected document in the folder. The user operation to move the selected document to the folder is confirmed when the dragging of the document to the folder is detected. The user operation to register the selected document in the folder is confirmed when the dropping of the document on the folder is detected.

In step S804, the information processing apparatus 100 extracts the log information on the specified folder. In step S806, the information processing apparatus 100 extracts the log information on all folders currently displayed on the display 162. The information processing apparatus 100 may extract the log information on a folder that is ready to be specified as a destination of the target document.

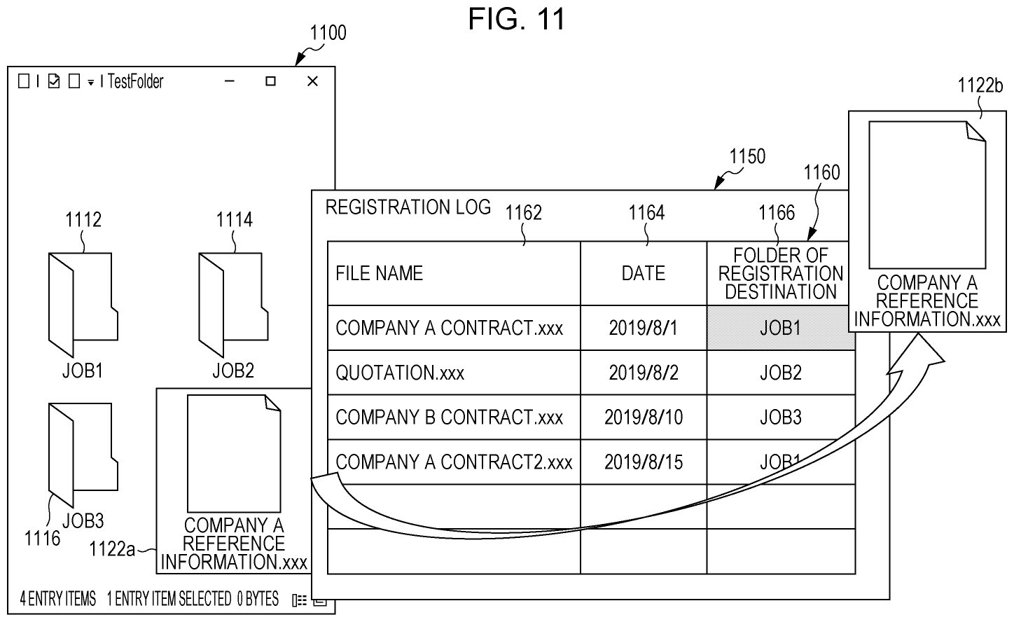

FIG. 11 illustrates a process example of the exemplary embodiment. Referring to FIG. 11, if the document is specified, the log of a folder that may be a target is displayed on the display 162. FIG. 11 illustrates in detail the operation in step S806 of the flowchart in FIG. 8. Referring to FIG. 11, the operation to move and register the selected document in the folder in the displayed log is also performed.

An operation folder display screen 1100 displays three folders (job 1 folder 1112, job 2 folder 1114, and job 3 folder 1116) and a document (company A reference information.xxx 1122). In response to the user operation that has selected the company A reference information.xxx 1122a, the information processing apparatus 100 displays a log information display region 1150. The selection may be carried out by a user right click operation on the mouse or a user hot key operation. If the operation is detected, the information processing apparatus 100 displays the log information display region 1150.

The log information display region 1150 displays a log information display subregion 1160. The log information on the job 1 folder 1112, job 2 folder 1114, and job 3 folder 1116 on the operation folder display screen 1100 is displayed on the log information display subregion 1160. The company A reference information.xxx 1122a may possibly be registered in one of those folders.

The log information display subregion 1160 includes a file name column 1162, date column 1164, and registration destination column 1166. The file name column 1162 displays the file name of the document. The date column 1164 displays the date on which the document has been registered. The registration destination column 1166 displays the folder in which the document has been registered.

The first row of the log information display subregion 1160 displays company A contract.xxx as the file name, 2019/8/1 as the date, and job 1 as the destination of the registration folder. The second row of the log information display subregion 1160 displays quotation.xxx as the file name, 2019/8/2 as the date, and job 2 as the destination of the registration folder. The third row of the log information display subregion 1160 displays company B contract.xxx as the file name, 2019/8/10 as the date, and job 3 as the destination of the registration folder. The fourth row of the log information display subregion 1160 displays company A contract2.xxx as the file name, 2019/8/15 as the date, and job 1 as the destination of the registration folder.

Since the log information display subregion 1160 is displayed to the user with the document company A reference information.xxx1122 selected, the user is able to narrow folders in accordance with the attribute information on the folders. Specifically, the user may simply select a folder where a document similar to the document company A reference information.xxx 1122 has been registered.

The log information displayed in the log information display subregion 1160 may be extracted from the document similar to the company A reference information.xxx 1122. The similar documents may be documents having words common thereto with the number of the common words higher than a predetermined threshold value or may be documents similar in type to each other.

The log information displayed on the log information display subregion 1160 may be related to a folder including registered documents higher in number than a predetermined threshold value. A folder with a relatively smaller number of documents registered therewithin may be difficult to reference in the determination as to whether the document is to be registered in the folder.

The user may select the company A reference information.xxx 1122a, move the company A reference information.xxx 1122a to the registration destination column 1166 at the first row of the log information display subregion 1160 (the location of the company A reference information.xxx1122b in FIG. 11), and register the company A reference information.xxx 1122a in the folder denoted by the job 1. These operations are typically referred to as a drag and drop operation. The folder denoted by the job 1 corresponds to the job 1 folder 1112. Specifically, the registration of the company A reference information.xxx 1122 in the job 1 folder 1112 may be performed on the log information display subregion 1160 displayed when the company A reference information.xxx 1122 is selected. The operation assigned to the job 1 folder 1112 is performed on the company A reference information.xxx 1122. Information on the company A reference information.xxx 1122 is thus registered as the log information on the job 1 folder 1112.

The company A reference information.xxx 1122a is in the operation folder display screen 1100. Alternatively, the company A reference information.xxx 1122a may be in the desk top. The folders displayed in the log information display subregion 1160 may correspond to the folders in the operation folder display screen 1100.

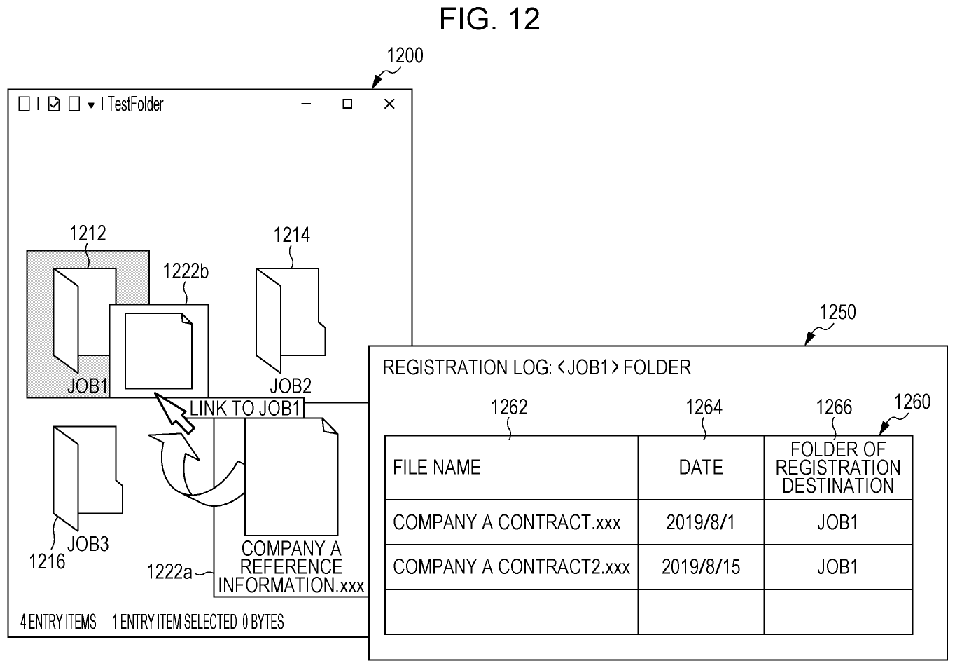

FIG. 12 illustrates a process example of the exemplary embodiment. Referring to FIG. 12, if the user operation to move the selected document to the folder is performed, the log of the folder is displayed on the display 162.

An operation folder display screen 1200 displays three folders (a job 1 folder 1212, job 2 folder 1214, and job 3 folder 1216) and a document (company A reference information.xxx 1222). If the user selects the company A reference information.xxx 1222a and moves the company A reference information.xxx 1222a to the job 1 folder 1212 (if a drag operation to drag to the location of the company A reference information.xxx 1222b is detected as in FIG. 12), a log information display region 1250 will be displayed.

The log information display region 1250 displays a log information display subregion 1260. The contents of the log information display subregion 1260 are log information on the job 1 folder 1212.

The log information display subregion 1260 includes a file name column 1262, date column 1264, and registration destination folder column 1266. The file name column 1262 displays the file name of the document. The date column 1264 displays the date on which the document has been registered in the job 1 folder 1212. The registration destination folder column 1266 displays the folder in which the document has been registered. Referring to FIG. 12, only the job 1 folder 1212 is displayed.

The first row of the log information display subregion 1260 displays is company A contract.xxx as the file name, 2019/8/1 as the data, and job 1 as the registration destination folder. The second row of the log information display subregion 1260 displays is company A contract2.xxx as the file name, 2019/8/15 as the data, and job 1 as the registration destination folder.

Since the log information display subregion 1260 is displayed to the user with the company A reference information.xxx 1222 moved to the job 1 folder 1212, the user may determine in accordance with the attribute information on the company A reference information.xxx 1222 whether to register in the company A reference information.xxx 1222. Specifically, if a document similar to the company A reference information.xxx 1222 has been registered, the user selects the job 1 folder 1212. If a document similar to the company A reference information.xxx 1222 has not been registered, the user moves to a folder other than the job 1 folder 1212 and displays the log of that folder.

FIG. 13 illustrates a display example of a screen 1300 of the exemplary embodiment, namely, a display example in step S414 in the flowchart in FIG. 4. If the type of the selected document is not similar to the type of a document registered in a folder serving as a destination, a warning against registering the document in that folder is displayed.

The screen 1300 displays a confirm message region 1310, yes button 1320, and no button 1330.

The confirm message region 1310 may display a message, for example, “Attribute and form of document are not related to registered document. Do you continue?”.

The process example in FIG. 11 and the process example in FIG. 12 may be combined. In such a case, the disclosure may be construed as described below. The disclosure is related to an information processing apparatus including a memory having stored a folder that is set to perform an operation related to a document if the document is registered in the folder and a log of documents registered in the folder, and one or more processors configured to, if the document is selected, perform control to display the log a display and configured to perform control to, if the document is superimposed on at least part of the folder, the log of the folder on the display.

The disclosure is related to an information processing apparatus including a memory having stored a folder that is set to perform an operation related to a document if the document is registered in the folder and a log of documents registered in the folder, and one or more processors configured to perform control to, if the document is selected, display the log on a display, the log to be displayed including information on the folder having the registered document, and configured to perform control to, if the document is superimposed on at least part of the folder in the displayed folder, display the log of the folder on the display.

Displaying the log may be set to be performed in two phases. In the first phase, the log of all folders serving as registration targets may be displayed and in the second phase, only the log of the folder serving as a target may be displayed.

The program described above may be provided in the recorded form on a recording medium or by a communication medium. The program described above may be construed as a computer readable non-transitory recording medium storing the program.

The computer readable non-transitory recording medium refers to as a recording medium that is used to install, execute, and/or distribute the program.

The recording media include digital versatile disk (DVD), compact disk (CD), Blu-ray disc (registered trademark), magnetooptical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired and wireless networks may include a local-area network (LAN), metropolitan-area network (MAN), wide-area network (WAN), the Internet, intranet, and extranet. The program in whole or in part may be transmitted over a carrier wave.

The program may be part of another program, or may be stored on the recording medium together with another program. The program may be split and the split programs may then be separately stored on the recording media. The program may be processed in any fashion before being stored as long as the program remains restorable. For example, the program may be compressed or encrypted before storage.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory having stored a folder that is set to perform an operation related to a document if the document is registered in the folder and a log of documents registered in the folder; and
one or more processors configured to,
if the document is selected, perform control to display the log.

2. The information processing apparatus according to claim 1, wherein the displayed log includes information on the folder having the registered document, and
wherein the processor is configured to,
if an operation to move and register the selected document in a folder in the displayed log is performed, register the selected document in the folder.

3. The information processing apparatus according to claim 2, wherein the log includes a word extracted from the registered document, and
wherein the processor is configured to,
if an operation to move the document or an operation to superimpose the document is performed and a word from among words extracted from the selected document matches a word in the log stored on the memory, register the document in a folder serving as a destination.

4. The information processing apparatus according to claim 2, wherein the processor is configured to,
if an operation to move the document or an operation to superimpose the document is performed and a type of the selected document is similar to a type of a document registered in a folder serving as a destination, register the document in the folder.

5. The information processing apparatus according to claim 2, wherein the processor is configured to,
if an operation to move the document or an operation to superimpose the document is performed and a type of the selected document is not similar to a type of a document registered in a folder serving as a destination, display a warning against registering the document in the folder.

6. An information processing apparatus comprising:
a memory having stored a folder that is set to perform an operation related to a document if the document is registered in the folder and a log of documents registered in the folder; and
one or more processors configured to,
if a selected document is superimposed on at least part of the folder,
perform control to display the log of the folder on a display.

7. The information processing apparatus according to claim 6, wherein the log includes a word extracted from the registered document, and
wherein the processor is configured to,
if an operation to move the document or an operation to superimpose the document is performed and a word from among words extracted from the selected document matches a word in the log stored on the memory, register the document in a folder serving as a destination.

8. The information processing apparatus according to claim 6, wherein the processor is configured to,
if an operation to move the document or an operation to superimpose the document is performed and a type of the selected document is similar to a type of a document registered in a folder serving as a destination, register the document in the folder.

9. The information processing apparatus according to claim 6, wherein the processor is configured to,
if an operation to move the document or an operation to superimpose the document is performed and a type of the selected document is not similar to a type of a document registered in a folder serving as a destination, display a warning against registering the document in the folder.

10. A non-transitory computer readable medium storing a program causing a computer to execute a process for processing information, the process comprising:
storing a folder that is set to perform an operation related to a document if the document is registered in the folder and a log of documents registered in the folder; and
performing control to display the log if the document is selected.

11. A non-transitory computer readable medium storing a program causing a computer to execute a process for processing information, the process comprising:
storing a folder that is set to perform an operation related to a document if the document is registered in the folder and a log of documents registered in the folder; and
performing control to display the log of the folder on a display if a selected document is superimposed on at least part of the folder.
